(19) United States
(12) Patent Application Publication
(10) Pub. No.: US 2021/0158056 A1
(43) Pub. Date: May 27, 2021

(54) MOOD-BASED RISK ASSESSMENT OF INDIVIDUALS OF A CROWD IN A PUBLIC SPACE

(71) Applicant: INSTITUT NATIONAL D'OPTIQUE, Quebec (CA)

(72) Inventors: Pierre GALARNEAU, Quebec (CA); Suzie DUFOUR, Quebec (CA); LoÏc LE NOC, Quebec (CA); André FOUGÈRES, Quebec (CA); Alain BERGERON, Quebec (CA)

(21) Appl. No.: 17/100,186

(22) Filed: Nov. 20, 2020

Related U.S. Application Data
(60) Provisional application No. 62/939,137, filed on Nov. 22, 2019.

(51) Int. Cl. G06K 9/00; G06T 7/20; G06K 9/62; H04N 5/247; G06Q 50/26

(52) U.S. Cl. CPC G06K 9/00778; G06T 7/20; G06K 9/00335; G06K 9/6217; G06K 9/6267; G06T 2207/20084; G06K 9/00362; G06Q 50/265; G06T 2207/30196; G06T 2207/30232; H04N 5/247

(57) ABSTRACT

Methods and systems for crowd surveillance in a public space are provided. The public space has one or more entry points each associated with a corresponding entry zone. Using an entry sensor network, each individual accessing the public space through one of the entry zones is tagged. Each tagged individual is then tracked using the entry sensor network and an interior sensor network. A mood analysis based on data acquired by at least the entry sensor network is performed and includes evaluating at least one physiological or behavioral parameter representative of an emotional state of the individual. A mood-based risk assessment of the individual is then performed based on the mood analysis.

### TECHNICAL FIELD

The technical field generally relates to security threats prevention and more particularly concerns systems and methods for crowd surveillance in a public space.

### BACKGROUND

Emerging threats from non-state actors and increasing demand for military operations in urban environment requiring differentiation between combatants and non-combatants have increased the complexity of operations and the need for identifying possible menaces in crowded and public areas. Most of the currently existing technologies and safety procedures aim to detect the threats themselves. Metal detectors, X-rays, THz and millimeter-wave imagers, dogs and IMS (Ion Mobility Spectrometry) are efficient technologies for detecting concealed weapons, bombs and inflammables. However, these methods are localized and require time which often generate waiting lines themselves presenting new targets, as it was the case in Belgium in 2016.

Profiling and behavior analyses are also effective to provide additional screening targets. To prevent mass threatening action, the risk level of individuals should be assessed in crowded area rapidly, without perturbing the flow of people or their normal activities. Some strategies to improve the response time to a situation are based on motion analysis of a crowd via video or geo-localization of cellular phones. Others are based on mood assessment of the crowd through analysis of audio, text and photo/video from phones and social media posting originating from a given area. Millimeter-wave radars can also be used to assess the level of engagement of an individual into an activity, based on its heart rate and respiration.

There remains a need for improved systems and methods for security monitoring of crowds. In some implementations, the monitoring should preferably be covert and should not require cooperation from targets or additional markers or devices such as cellular phones.

### SUMMARY

In accordance with one aspect, there is provided a method for crowd surveillance in a public space having one or more entry points, each entry point being associated with a corresponding entry zone. The method includes the steps of:
a) using an entry sensor network, tagging each individual accessing the public space through one of the entry zones; and
   for each individual having been tagged:
b) tracking the individual using the entry sensor network and an interior sensor network;
c) performing a mood analysis on the individual based on data acquired by at least the entry sensor network, the mood analysis including evaluating at least one physiological or behavioral parameter representative of an emotional state of the individual; and
d) performing a mood-based risk assessment of the individual based on the mood analysis to evaluate a risk level of said individual.

In some implementations, the step of tagging each individual includes detecting the entry of the individual in the public space through one of the entry points, and assigning an identifier to the individual.

In some implementations, detecting the entry of an individual includes:
detecting a significant environment change in the one of the entry points; and
recognizing a nature of said environment change using a classifier based on a neural network.

In some implementations, the at least one physiological or behavioral parameter representative of an emotional state of the individual includes a heart rate of the individual.

In some implementations, the at least one physiological or behavioral parameter representative of an emotional state of the individual includes a breath rhythm of the individual.

In some implementations, the at least one physiological or behavioral parameter representative of an emotional state of the individual includes a skin conductivity of the individual.

In some implementations, the at least one physiological or behavioral parameter representative of an emotional state of the individual includes abnormal behavioral characteristics.

In some implementations, the step of performing a mood-based risk assessment of the individual includes comparing the at least one physiological or behavioral parameter representative of an emotional state of the individual to reference data representing expected parameters for individuals without threatening intents.

In some implementations, the method includes a step of comparing the risk level of the individual to a risk threshold, and:
if the risk level of the individual is above the risk threshold, assigning a threat status to the individual and notifying security staff; and
if the risk level of the individual is below the risk threshold, stopping the tracking of the individual and uncaging the individual.

In some implementations, the method includes a step of comparing the risk level of the individual to a risk threshold, and:
if the risk level of the individual is above the risk threshold, assigning a threat status to the individual and notifying security staff; and
if the risk level of the individual is below the risk threshold, performing a step of monitoring the individual for an increased risk level indicator, and, if said increased risk level indicator is detected, returning to the step of performing a mood analysis of the individual.

In accordance with another aspect, there is provided a crowd monitoring system for crowd surveillance in a public space having one or more entry points, each entry point being associated with a corresponding entry zone.

The crowd monitoring system includes an entry sensor network having a plurality of entry sensors collectively covering the entry zones, and an interior sensor network having a plurality of interior sensors collectively covering remaining areas of the public space not covered by the entry sensor network.

The crowd monitoring system further includes a crowd surveillance device in communication with the entry sensor network and the interior sensor network. The crowd surveillance device includes:
a tagging module configured to tag each individual accessing the public space through one of the entry zones;
a tracking module configured to track each individual having been tagged, the tracking module using the entry sensor network and the interior sensor network,
a mood analysis module configured to perform a mood analysis of each individual based on data acquired by at least the entry sensor network, the mood analysis including evaluating at least one physiological or behavioral parameter representative of an emotional state of the individual; and
a risk assessment module configured to perform a mood-based risk assessment of the individual based on the mood analysis to evaluate a risk level of the individual.

In some implementations, each one of the plurality of entry sensors and the plurality of interior sensors includes near-infrared cameras, visible cameras or thermal cameras.

In some implementations, the tagging module includes a neural network classifier trained in detecting a significant environment change in the one of the entry points using data from the entry sensors and being further trained in recognizing a nature of this environment change.

In some implementations, the risk-assessment module further includes one or more neural networks, trained in evaluating the risk level of the individual using the at least one physiological or behavioral parameter as input.

In some implementations, the at least one physiological or behavioral parameter includes at least one of a heart rate, a breath rhythm and a skin conductivity.

In some implementations, the at least one physiological or behavioral parameter representative of an emotional state of the individual includes abnormal behavioral characteristics.

In some implementations, the risk assessment module is configured to compare the risk level of the individual to a risk threshold and notify security staff if the risk level of the individual is above the risk threshold.

In accordance with another aspect, there is provided a tangible readable medium having stored thereon processor-readable instructions for crowd surveillance in a public space having one or more entry points, each entry point being associated with a corresponding entry zone. The processor-readable instructions cause a computing system to:
tag each individual accessing the public space through one of said entry zones; and
for each individual having been tagged:
   track the individual using an entry sensor network and an interior sensor network;
   perform a mood analysis on said individual based on data acquired by at least the entry sensor network, said mood analysis including evaluating at least one physiological or behavioral parameter representative of an emotional state of said individual; and
   perform a mood-based risk assessment of said individual based on the mood analysis to evaluate a risk level of said individual.

In some implementations, the stored processor-readable instructions further cause the computing system to notify security staff if the risk level of said individual is above a risk threshold.

In some implementations, the at least one physiological or behavioral parameter comprises at least one of a heart rate, a breath rhythm, a skin conductivity or abnormal behavioral characteristics.

In accordance with one aspect, there is provided a monitoring system for the crowd surveillance of a public space having one or more entry points each associated with an entry zone. The system includes an entry sensor network covering the entry zones. The entry sensor network is configured to perform the detection, tagging and initiate tracking of every individual entering the area. The system further includes an interior sensor network comprising a plurality of interior sensors, collectively covering the remaining areas of the public space not covered by the entry sensor network. The system also includes a crowd surveillance device configured to perform a mood-based risk assessment for every individual entering the space, the mood-based risk assessment including a mood analysis involving evaluating at least one physiological or behavioral parameter representative of the emotional state of each individual, based on data acquired by the entry sensor network.

In accordance with another aspect, there is provided a method for the crowd surveillance of a public space having one or more entry points each associated with an entry zone. The method includes the steps of:
a) using an entry sensor network, tagging new individuals accessing the entry zone;
b) tracking each tagged individual using the entry sensor network and an interior sensor network;
c) performing a mood analysis of each tagged individual, including evaluating at least one physiological or behavioral parameter representative of the emotional state of each individual, based on data acquired by the entry sensor network;
d) performing a mood-based risk assessment of said individual based on the mood analysis, and if a risk level is evaluated above a risk threshold, assigning a threat status to this individual and notifying security staff.

In some embodiments, if the risk level of an individual is evaluated below the risk threshold, the tracking of this individual is stopped, and the individual is untagged. In other variants, tracking of some or all the individuals may continue even if the associated risk level is evaluated below the risk threshold. The continued tracking may include monitoring a pre-defined set of activities and/or behaviors indicative of increased risk level, such as for example excess or absence of movements for a long period of time or increase of time spent in the vicinity of a vulnerability point of the area. The detection of such an activity or behavior may trigger a new mood-based risk assessment. In such embodiments, mood evaluation sensors should cover the overall area.

In some embodiments, the entry sensor network and interior sensor network may include one or more cameras acquiring images for analysis. In other embodiments one or both of the sensor networks may involve microphones, lidars, NIR (near-infrared) reflectometers or any other types of sensors apt to acquire data useful in evaluating physiological or behavioral parameters representative of the mood of an individual.

Other features and advantages of the invention will be better understood upon a reading of embodiments thereof with reference to the appended drawings.

### BRIEF DESCRIPTION OF THE DRAWINGS

FIG. 1 is a schematized representation of a public space provided with a monitoring system according to one embodiment.

FIG. 2 is a block diagram of a crowd surveillance device according to one embodiment.

FIGS. 3A and 3B are flow charts of crowd surveillance methods according to embodiments.

FIG. 4 is a graph of the typical spectrum of hemoglobin in the visible and near-infrared wavelength regions.

### DETAILED DESCRIPTION

The present description generally relates to methods and systems using non-contact techniques to monitor physiological or behavioral parameters of individuals in a crowd, for threat prevention. In some implementations, this monitoring can help identify one or more individuals having a heightened emotional state, for surveillance and early intervention purposes.

In some implementations, the methods and systems described herein may be used in public spaces where crowds of people gather, and terrorists or other dangerous individuals could be present. The public space may be indoors and/or outdoors, and is preferably delimited by walls, barriers, fences or the like through which are provided one or more entry points. The space may for example be or be a part of a transport-related facility such as an airport, a train station, a maritime port, a bus station, a subway station, etc. Other examples include stadiums, theaters, conference centers and other locations of public events such as sports events, political meetings, shows, rallies and the like. It will be readily understood that the list above is non-exhaustive and that the present methods and systems may be used in any space where crowd safety is an issue.

In accordance with one aspect, the systems and methods described herein make use of non-contact monitoring techniques to measure a variation of one or more physiological or behavioral parameters of the individuals in the space. It has been demonstrated that strong emotions can be detected by remotely measuring the cardiac and breath rhythms of an individual using wireless signals (see for example Zhao et al., Emotion recognition using wireless signals, Proceedings of the 22nd Annual International Conference on Mobile Computing and Networking, pages 95-108. New York City, N.Y. —October 03-07, 2016). As individuals on the verge of taking a threatening action against a crowd are more likely to be in a heightened emotional state, the identification and surveillance of the individuals meeting this condition can help security personnel and systems to intervene before the threatening action is taken.

### Monitoring System

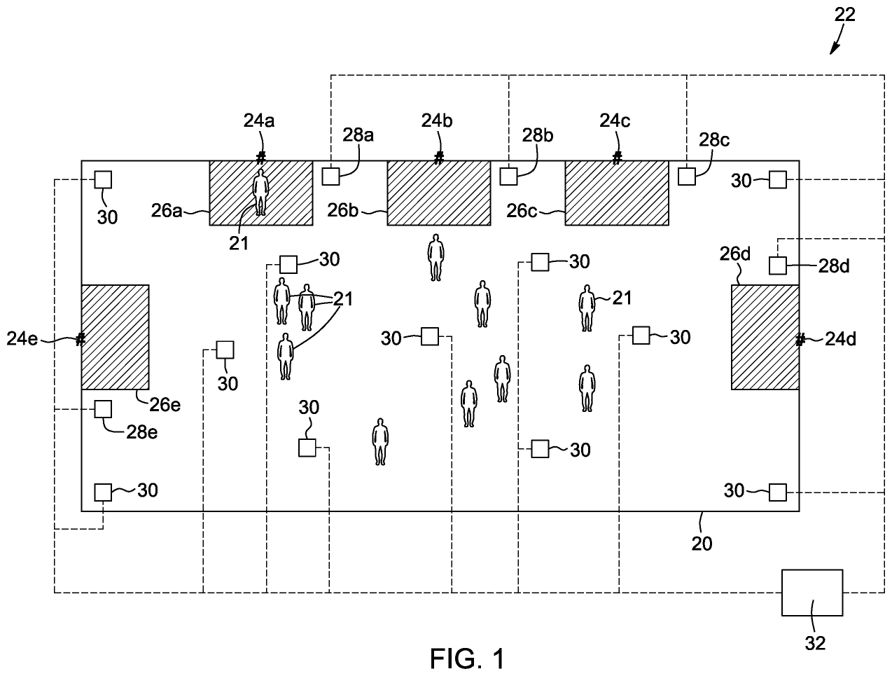

With reference to FIG. 1, there is shown an example of a public space 20 provided with a crowd monitoring system 22 according to one implementation.

The public space 20 has one or more entry points 24 through which individuals 21 can access the public space 20. The entry points may be gated and/or secured, although in some embodiments the entry points 24 may provide free access to the public space 20. Each entry point 24 may allow unidirectional access to the public space 20 (entry only) or bidirectional access (entry and exit). In the illustrated variant, five entry points 24a, 24b, 24c, 24d and 24e are shown, but any number of entry points suitable for the public space 20 may be provided in other implementations. Each entry point 24a, 24b, 24c, 24d and 24e is associated with a corresponding entry zone 26a, 26b, 26c, 26d and 26e.

The crowd monitoring system 22 also includes an entry sensor network comprising a plurality of entry sensors 28 collectively covering the entry zones 26. In some embodiments, the plurality of entry sensors 28 includes at least one entry camera 28a, 28b, 28c, 28d and 28e associated with each entry zone 26a, 26b, 26c, 26d and 26e. It will be readily understood than multiple entry cameras may be used in association with each entry zone 26, and that different entry zones 26 may be provided with a different number and configuration of entry cameras 28. By “covering” the entry zone 26, it is preferably meant that the common field of view defined by the combination of the singular fields of view of the entry cameras 28 allows the observation of each individual 21 as he or she enters the space. It could also be said that each entry zone 26 is associated with a given entry point 24 and is defined by the common field of view of the entry cameras 28 (or the singular field of view of a single camera) allowing the observation of individuals 21 as they enter the public space 20 through this particular entry point 24. In some implementations, the coverage of the entry sensor network is designed so as to be sufficient to prevent the undetected entry of an individual within the public space 20. As explained further below, the entry sensor network preferably provides data which can be used to perform the detection, tagging and tracking of every individual entering the public space 20. As also explained further below, data acquired by the entry sensor network is also used to perform mood assessment of each individual.

Each entry camera 28 may for example be a near infrared (NIR) camera, a visible camera (RGB or black and white), a thermal (IR) camera or another type of camera or sensor allowing the detection of a physiological or behavioral parameter representative of the emotional state of an individual, as explained below. It will be understood that the entry sensors 28 of the entry sensor network may all be of a same type or may be a combination of cameras or other sensors of different types.

It will also be readily understood that while the description below pertains to embodiments where cameras are used as the sensors of the entry sensor network, in other implementations different types of sensing devices and associated data may be used without departing from the scope of protection.

The crowd monitoring system 22 further includes an interior sensor network comprising a plurality of interior sensors or cameras 30, collectively covering the remaining areas of the public space 20 not covered by the entry sensor network. Again, it will also be readily understood that while the description below pertains to embodiments where cameras are used as the sensors of the interior sensor network, in other implementations different types of sensing devices and associated data may be used without departing from the scope of protection. It will be understood that, in some implementations, the collective field of view of the interior cameras 30 may intersect some of the fields of view of the entry cameras 28 without departing from the scope of the present description. The interior cameras 30 may be similar to the entry cameras 28, and may for example include near-infrared (NIR) cameras, visible cameras (RGB or black and white), thermal (IR) cameras or the like. In some embodiments, the interior cameras 30 may have a lower resolution than the entry cameras 28. The interior sensor network may include various combinations of camera types and the interior cameras 30 may be distributed in a grid over the public space 20 or any configuration allowing the desired degree of monitoring of the individuals 21 within the public space 20. As further explained below, the interior sensor network is configured so as to provide a coverage sufficient to allow tracking of individuals within the public space 20 at least until a risk level associated with each individual has been evaluated.

The crowd monitoring system 22 also includes a crowd surveillance device 32. The crowd surveillance device 32 is preferably configured to provide a surveillance of the individuals 21 in the public space 20, as explained in more details below. The crowd surveillance device 32 is in wired and/or wireless communication with the entry sensor network and the interior sensor network. In some embodiments, the crowd surveillance device 32 may be embodied by one or more processors and associated computing components programmed with instructions to carry out the steps of the present surveillance method. The components of the crowd surveillance device 32 may define a plurality of modules each configured to perform a specific task. Different components of the crowd surveillance device 32 may collaborate together to implement a given module and perform the associated function. One or more physical components embodying the crowd surveillance device 32 may be located proximate the public space 20 or at a remote location.

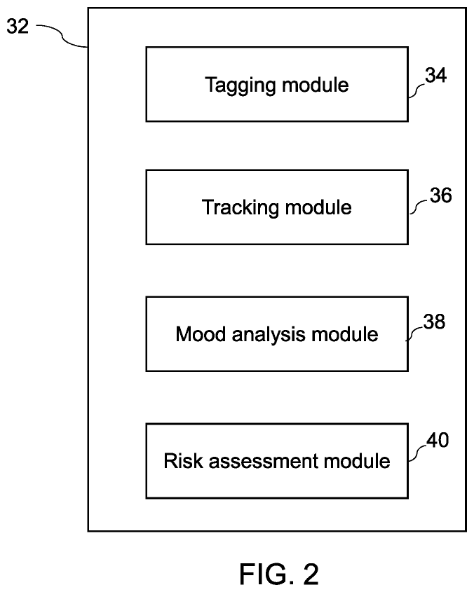

Referring to FIG. 2, in some implementations the crowd surveillance device 32 may include a tagging module 34, a tracking module 36, a mood analysis module 38 and a risk assessment module 40.

The tagging module 34 may be configured to tag each individual accessing the public space through one of the entry zones. By way of example, the tagging module may include a neural network classifier, such as for example a Deep Neural Network (DNN) or the like, trained in detecting a significant environment change in one of the entry points using data from the entry sensors, and being further trained in recognizing a nature of this environment change.

The tracking module 36 is preferably configured to track each individual having been tagged using the entry sensor network and the interior sensor network.

The mood analysis module 38 is preferably configured to perform a mood analysis of each individual based on data acquired by the entry sensor network, possibly combined with data acquired by the interior sensor network. The mood analysis includes evaluating at least one physiological or behavioral parameter representative of an emotional state of an individual, such as heart rate, breath rhythm, skin conductivity and abnormal behavioral characteristics.

Finally, the risk assessment module 40 is configured to perform a mood-based risk assessment of the individual based on the mood analysis, to evaluate a risk level of this individual. By way of example, the risk assessment module may be configured to compare the risk level of the individual to a risk threshold, and notify security staff if the risk level of the individual is above the risk threshold.

In some implementations, at least some of the functions performed by the crowd surveillance device 32 and any of the modules listed above are accomplished using Artificial Intelligence (AI). In some implementations, the system 22 may have one or more AI engines, such as one or more neural networks. The AI engines may each be trained using appropriate training sets. The training sets can be sets of physiological parameters that have been obtained during a training phase. The sets can include heart rate measurements for a plurality of individuals, breath rhythm, epidermal conductivity as well as behavioral characteristics and/or a combination thereof. For example, when trained and deployed, the trained AI engines can extract features from physiological and/or behavioral parameters measurements of an individual, classify the features and output a reading indicative of mood-based risk level of the individual.

### Crowd Surveillance Method

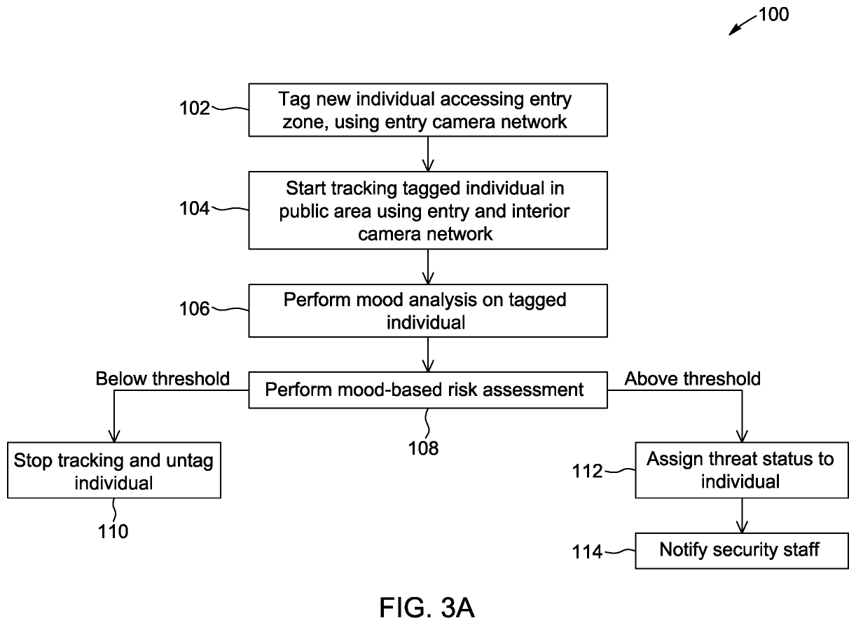

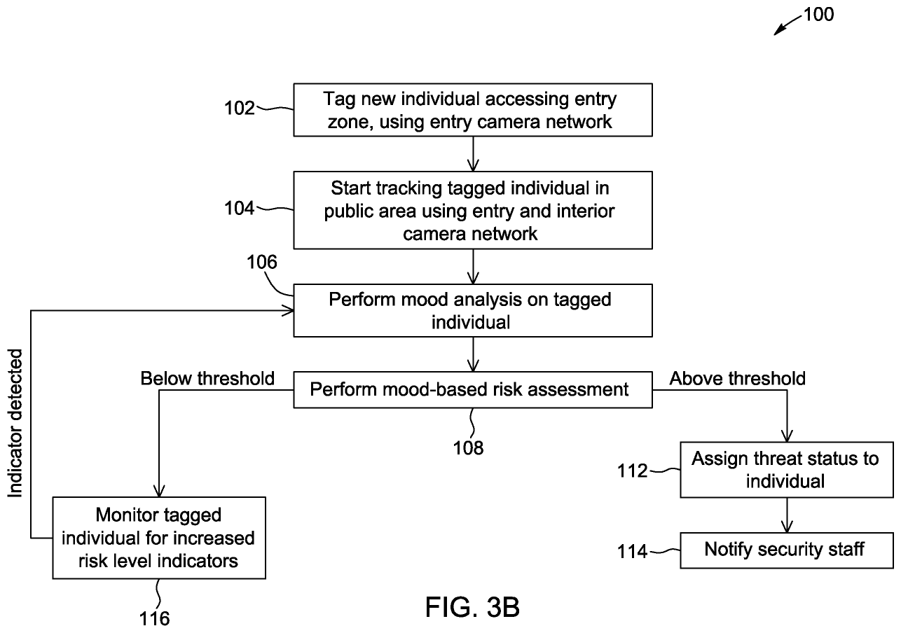

With additional reference to FIG. 3A, there is shown a flow chart illustrating a crowd surveillance method 100 according to one embodiment.

The method 100 first includes a step 102 of tagging each individual accessing the public space through one of the entry zones, using the entry sensor network. In some implementations, the process of tagging each individual may include detecting the entry of a new individual in the public space through one of the entry points, and assigning an identifier to the individual such as a code, a serial number, or the like. By way of example, detecting the entry of an individual may involve the detection of a significant change of the environment followed by a recognition of the nature of the change (human being, animal, suitcase, etc.) using classifiers based on a neural network. For example, a Deep Neural Network such as Convolutional Neural Network or Recurrent Neural Network may be used.

For each individual having been tagged, the following series of steps is then preferably performed.

The method 100 includes a step 104 of tracking the individual using the entry sensor network and the interior sensor network. Preferably, as soon as an individual has been tagged, the tracking begins and continues as he or she moves about the public space. Preferably both entry and interior sensor networks are used for the tracking. Tracking may be performed by following the trajectory of a tagged individual and associated changes of the environment. As will be explained below, in some implementations the tracking of the individuals is a temporary measure which is performed while the crowd surveillance device 32 performs a mood-based risk assessment of the individual.

The method 100 next includes a step 106 of performing a mood analysis on each individual.

The mood analysis 106 preferably includes evaluating at least one physiological or behavioral parameter representative of the emotional state of each individual, based on one or more images or other data acquired by the entry sensor network. Alternative embodiments may use the interior sensor network as well.

In some implementations different types of physiological parameters of the individuals may be evaluated, alone or in combination.

### Heart Rate Monitoring

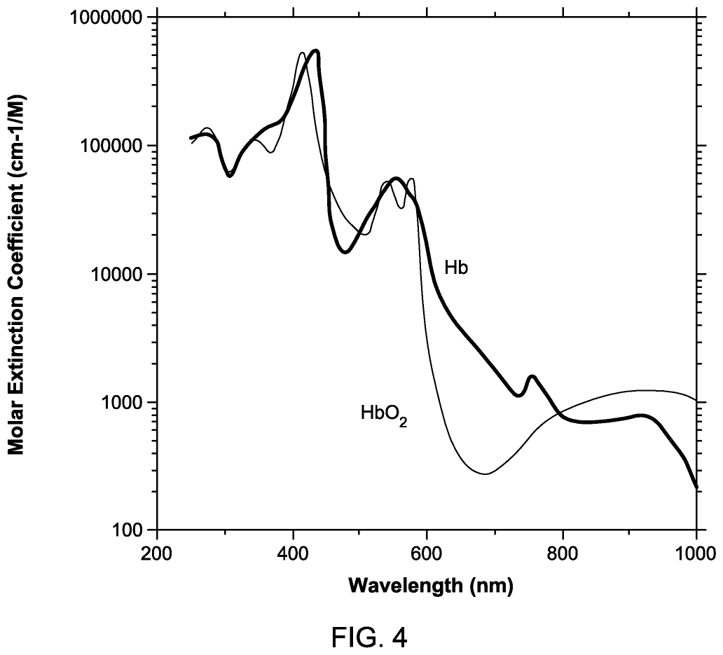

In one implementation, one monitored physiological parameter may be the heart rate of each individual having entered the space. As the human heart pumps blood through blood vessels, a corresponding color variation can be observed in the facial skin. It is known in the art that blood exhibits specific spectral structure in the visible and NIR spectral ranges (see FIG. 4, showing the best estimate of the spectrum of Hb and HbO₂ from a variety of sources, from the Oregon Medical Laser Center in Portland). Such features may be efficiently used to perform heart rate and blood oxygenation measurements.

In one example, portions of the images acquired by the entry cameras including the facial skin of each individual are located. A reflectance analysis of the identified image portion is then performed. The reflectance of a given wavelength is affected by blood absorption and varies over time according to blood perfusion. This analysis preferably includes measuring a change in light absorption of at least two different wavelengths, representative of oxygenated blood and deoxygenated blood. As for example known in the art of pulse oximetry, combinations of wavelengths in the red and/or NIR ranges can be used for this purpose, such as 760 nm/800 nm, or 630 nm/940 nm

In one embodiment, the skin surface of each individual entering the space through an entry point is illuminated, for example using a light source projecting NIR light onto the face of the individual. Interaction of the projected light with the skin surface leads to light scattering, the intensity of the scattered light being affected by the amount of absorption occurring in the skin, which is wavelength-dependent. The scattered light or a portion thereof may be collected using a lens and/or other optical components and focused onto a detector. The resulting detector signal can vary in time representatively of blood perfusion, hence heart rate. By taking the ratio of at least two measurements taken at different wavelengths corresponding to different features of the blood absorption spectra, one would prevent artefact measurements coming from surface motion and/or air transmission variation.

### Breath Rhythm Monitoring

In one implementation, one monitored physiological parameter may be the breath rhythm of each individual. Several approaches may be used to measure respiratory rate, including laser Doppler measurement of the chest movement, nostril temperature variation due to air flow measured using an IR camera, 3D and acoustic measurements. In the case of acoustic measurements, an array of microphones may be placed around the entry zone with low-pass frequency filters. Mixing the microphone signal with the proper phase adjustment can provide measurement on the target individual.

### Epidermal Conductivity Monitoring

In one implementation, one monitored physiological parameter may be the skin conductivity of each individual. Skin conductivity is known to be dependent on stress factor, and is for example monitored by a polygraph. Skin conductivity is affected by humidity level of the skin, ion migration and blood content which also affect electrical permittivity at higher frequency. A variation of the collimated radiation reflectivity therefore correlates with change in electrical permittivity, revealing emotional state. Such collimated radiation can be THz or RF signal.

### Behavioral Parameter

In some implementations, abnormal behavioral characteristics that may reveal threatening intentions of an individual may be identified via video analytics. In some embodiments, artificial intelligence algorithms may be used to assist the analysis. Such characteristics may include excessive nervousness, empty eyes or a blank stare, other behaviors associated with Post Traumatic Stress Syndrome, etc. Behavioral parameters may be evaluated independently or in combination with physiological parameters.

It will be readily understood that other physiological and/or behavioral parameters may be evaluated without departing from the scope of protection. Furthermore, in some variants, the mood analysis may involve evaluating two or more physiological and/or behavioral parameters.

The present method 100 next involves a step 108 of performing a mood-based risk assessment of the individual based on the mood analysis, to evaluate a risk level of the individual. The risk assessment may be based on the outcome of one or more of the analysis techniques described above or equivalents thereof. In some evaluations, the risk assessment evaluator uses artificial intelligence. By way of example, characteristic distances among certain facial landmarks can be used to evaluate facial expressions and consequently mood. In a similar way, heartbeat features, more specifically, their variation, can be used to classify emotions using deep learning frameworks. The physiological and/or behavioral parameters of an individual may be plotted on a multi-dimensional graph, and compared to reference data representing expected parameters for individuals without threatening intents. A safe zone within this multi-dimensional space may be established for comparative purposes, such that data points falling outside of this safe zone may be considered representing physiological characteristics above a risk threshold and requiring further attention. Other techniques may be used to determine whether or not the evaluated physiological and/or behavioral parameters translate to a risk level above or below a predetermined risk threshold.

In some implementations, if the risk assessment is below the risk threshold, the individual will be untagged at step 110 and tracking will be stopped. If the risk level of the individual is above the risk threshold, a threat status is assigned to the individual at step 112, and security staff is notified (step 114). For example, the attention of the security staff may be raised by highlighting the suspect individual and location of the possible threat will be given using an appropriate display in order to allow for specific surveillance and/or additional screening. Such an appropriate display could be a dedicated monitor displaying the possible threatening individual movements and actions.

Referring to FIG. 3B, there is shown another variant of the crowd surveillance method 100. In this implementation, tracking of some or all the individuals may continue even if the associated risk level is evaluated below the risk threshold. The continued tracking may include monitoring 116 the individuals for the onset of an increased risk level indicator. The increased risk level indicator may for example be one of a pre-defined set of activities and/or behaviors known to be indicative of an increased risk level, such as for example excess or absence of movements for a long period of time, or increase of time spent in the vicinity of a vulnerability point of the area. The detection of such an activity or behavior triggers a new mood-based risk assessment 108. In such embodiments, sensors providing the information used for mood analysis preferably cover the entire public space. This variant may be particularly useful to identify “dormant” terrorist elements who may not be aware, at the time of entry into the public space, that a threatening activity involving them is set to occur within this space. Such dormant elements are typically activated shortly before the threatening activity, for example through an electronic communication.

As will be readily understood by one skilled in the art, in some implementations a tangible readable medium having stored thereon processor-readable instructions for crowd surveillance in a public space having one or more entry points may be provided. In embodiments such as described above, each entry point is associated with a corresponding entry zone. The processor-readable instructions causes a computing system to:
tag each individual accessing the public space through one of said entry zones; and
for each individual having been tagged:
   track the individual using an entry sensor network and an interior sensor network;
   perform a mood analysis on said individual based at least on data acquired by the entry sensor network, said mood analysis including evaluating at least one physiological or behavioral parameter representative of an emotional state of said individual; and
   perform mood-based risk assessment of said individual based on the mood analysis to evaluate a risk level of said individual.

The stored processor-readable instructions may further cause the computing system to notify security staff if the risk level of the individual is above a risk threshold, as explained above. The at least one physiological or behavioral parameter may for example be embodied by or include a heart rate, a breath rhythm, a skin conductivity or abnormal behavioral characteristics of the individual.

Of course, numerous modifications could be made to the embodiments described above without departing from the scope of the invention.

1. A method for crowd surveillance in a public space having one or more entry points, each entry point being associated with a corresponding entry zone, the method comprising the steps of:
a) using an entry sensor network, tagging each individual accessing the public space through one of said entry zones; and
for each individual having been tagged:
b) tracking the individual using the entry sensor network and an interior sensor network;
c) performing a mood analysis on said individual based on data acquired by at least the entry sensor network, said mood analysis including evaluating at least one physiological or behavioral parameter representative of an emotional state of said individual; and
d) performing a mood-based risk assessment of said individual based on the mood analysis to evaluate a risk level of said individual.

2. The method according to claim 1, wherein the step of tagging each individual comprises detecting the entry of said individual in the public space through one of the entry points, and assigning an identifier to the individual.

3. The method according to claim 2, wherein detecting the entry of an individual comprises:
detecting a significant environment change in said one of the entry points; and
recognizing a nature of said environment change using a classifier based on a neural network.

4. The method according to claim 1, wherein the at least one physiological or behavioral parameter representative of an emotional state of said individual comprises a heart rate of the individual.

5. The method according to claim 1, wherein the at least one physiological or behavioral parameter representative of an emotional state of said individual comprises a breath rhythm of the individual.

6. The method according to claim 1, wherein the at least one physiological or behavioral parameter representative of an emotional state of said individual comprises a skin conductivity of the individual.

7. The method according to claim 1, wherein the at least one physiological or behavioral parameter representative of an emotional state of said individual comprises abnormal behavioral characteristics.

8. The method according to claim 1, wherein the step of performing a mood-based risk assessment of said individual comprises comparing said at least one physiological or behavioral parameter representative of an emotional state of said individual to reference data representing expected parameters for individuals without threatening intents.

9. The method according to claim 1, comprising a step of comparing the risk level of the individual to a risk threshold, and:
if the risk level of the individual is above the risk threshold, assigning a threat status to the individual and notifying security staff; and
if the risk level of the individual is below the risk threshold, stopping the tracking of the individual and untagging the individual.

10. The method according to claim 1, comprising a step of comparing the risk level of the individual to a risk threshold, and:
if the risk level of the individual is above the risk threshold, assigning a threat status to the individual and notifying security staff; and
if the risk level of the individual is below the risk threshold, performing a step of monitoring the individual for an increased risk level indicator, and, if said increased risk level indicator is detected, returning to step c).

11. A crowd monitoring system for crowd surveillance in a public space having one or more entry points, each entry point being associated with a corresponding entry zone, the crowd monitoring system comprising:
an entry sensor network comprising a plurality of entry sensors collectively covering the entry zones;
an interior sensor network comprising a plurality of interior sensors collectively covering remaining areas of the public space not covered by the entry sensor network; and
a crowd surveillance device in communication with the entry sensor network and the interior sensor network, the crowd surveillance device comprising:
a tagging module configured to tag each individual accessing the public space through one of said entry zones;
a tracking module configured to track each individual having been tagged, the tracking module using the entry sensor network and the interior sensor network,
a mood analysis module configured to perform a mood analysis of each individual based on data acquired by at least the entry sensor network, said mood analysis including evaluating at least one physiological or behavioral parameter representative of an emotional state of said individual; and
a risk assessment module configured to perform a mood-based risk assessment of said individual based on the mood analysis to evaluate a risk level of said individual.

12. The crowd monitoring system according to claim 11, wherein each one of the plurality of entry sensors and the plurality of interior sensors comprises near-infrared cameras, visible cameras or thermal cameras.

13. The crowd monitoring system according to claim 11, wherein the tagging module comprises a neural network classifier trained in detecting a significant environment change in said one of the entry points using data from the entry sensors and being further trained in recognizing a nature of said environment change.

14. The crowd monitoring system according to claim 11, wherein the risk-assessment module further comprises one or more neural networks trained in evaluating the risk level of said individual using the at least one physiological or behavioral parameter as input.

15. The crowd monitoring system according to claim 11, wherein the at least one physiological or behavioral parameter comprises at least one of a heart rate, a breath rhythm and a skin conductivity.

16. The crowd monitoring system according to claim 11, wherein the at least one physiological or behavioral parameter representative of an emotional state of said individual comprises abnormal behavioral characteristics.

17. The crowd monitoring system according to claim 11, wherein the risk assessment module is configured to compare the risk level of the individual to a risk threshold and notify security staff if the risk level of the individual is above the risk threshold.

18. A tangible readable medium having stored thereon processor-readable instructions for crowd surveillance in a public space having one or more entry points, each entry point being associated with a corresponding entry zone, the processor-readable instructions causing a computing system to:
tag each individual accessing the public space through one of said entry zones; and
for each individual having been tagged:
track the individual using an entry sensor network and an interior sensor network;
perform a mood analysis on said individual based on data acquired by at least the entry sensor network, said mood analysis including evaluating at least one physiological or behavioral parameter representative of an emotional state of said individual; and
perform a mood-based risk assessment of said individual based on the mood analysis to evaluate a risk level of said individual.

19. The tangible readable medium of claim 18, wherein the stored processor-readable instructions further cause the computing system to notify security staff if the risk level of said individual is above a risk threshold.

20. The tangible readable medium of claim 18, wherein the at least one physiological or behavioral parameter comprises at least one of a heart rate, a breath rhythm, a skin conductivity or abnormal behavioral characteristics.
